(19) United States
(12) Patent Application Publication
(10) Pub. No.: US 2012/0261489 A1
(43) Pub. Date: Oct. 18, 2012

(54) Atomizing nozzle with anti-leakage function

(76) Inventor: Hui San Hsu, Taichung City (TW)

(21) Appl. No.: 13/066,431

(22) Filed: Apr. 14, 2011

(51) Int. Cl. B05B 15/00

(52) U.S. Cl. 239/288

(57) ABSTRACT

An atomizing nozzle with an anti-leakage function includes a body, a cover, a rotor, a leak-stop assembly and an anti-leakage ring. One end of the body has an inclined accommodating groove having an arc curvature. The anti-leakage ring is disposed in the accommodating groove, and the cover presses the anti-leakage ring after being locked with one end of the body. The anti-leakage ring may correspond to a screwing position between the cover and the body, and is not located in a flowing path of the water or liquid. Thus, it is possible to prevent the water or liquid from flowing reversely or leaking to the screwing position, and to simplify the manufacturing processes.

### BACKGROUND OF THE INVENTION

1. Field of the Invention

The invention relates to the technological field of a micro-atomizing device, and more particularly to an atomizing nozzle capable of atomizing water or a liquid similar to the water and spraying the water or liquid in an atomized state.

2. Related Art

A typical spraying system or device may be disposed at an outlet end of an atomizing nozzle. When the water or liquid flows through the atomizing nozzle, the water or liquid may be sprayed in an atomized manner using a rotor disposed in a body of the atomizing nozzle and a water jet of the outlet end with a small aperture.

However, the atomizing nozzle contacts with the water or liquid for a long time, so that the elements thereof tend to get rusty or have the scale deposition, and screwing positions between the elements also tend to get rusty and have the scale deposition. Thus, the elements of the atomizing nozzle cannot be easily decomposed.

Referring to FIG. 1, a conventional atomizing nozzle (10) mainly includes a body (11), a rotor (12) and a leak-stop assembly (13) disposed in the body (11), and a combination of a cover (14) and a stopper block (15) disposed on one end of the body (11). More particularly, an annular groove (16) is formed on an inner surface of the cover (14), so that an anti-leakage ring (17) can be assembled in the annular groove (16).

When the combination of the cover (14), the anti-leakage ring (17) and the stopper block (15) is disposed on the end portion of the body (11), the anti-leakage ring (17) can correspond to a screwing position (18) between the body (11) and the cover (14). Thus, the water or liquid flows through a gap (19) between the rotor (12) and the body (11) without flowing reversely or leaking to the screwing position (18). Thus, the condition that the screwing position (18) gets rusty or has the scale deposition can be suppressed.

However, with the increase of the screwing force between the cover (14) and the body (11), the anti-leakage ring (17) tends to deform and thus congest the gap (19), thereby suppressing the water or liquid from flowing through the gap (19) smoothly. In addition, the machining processes of manufacturing the annular groove (16) on the inner surface of the cover (14) are significantly difficult.

### SUMMARY OF THE INVENTION

It is therefore a main object of the invention to provide an atomizing nozzle, which has the anti-leakage function for preventing the water or liquid from flowing reversely or leaking, and can be easily machined.

To achieve the above-mentioned object and effect, the invention discloses an atomizing nozzle with an anti-leakage function. The atomizing nozzle includes a body, a cover and an anti-leakage ring. One end of the body has an inclined accommodating groove having an arc curvature. The anti-leakage ring is disposed in the accommodating groove, and the cover presses the anti-leakage ring after being locked with one end of the body. The anti-leakage ring may correspond to a screwing position between the cover and the body, and is not located in a flowing path of the water or liquid. Thus, it is possible to prevent the water or liquid from flowing reversely or leaking to the screwing position, and to simplify the manufacturing processes.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing a structure of a conventional atomizing nozzle.

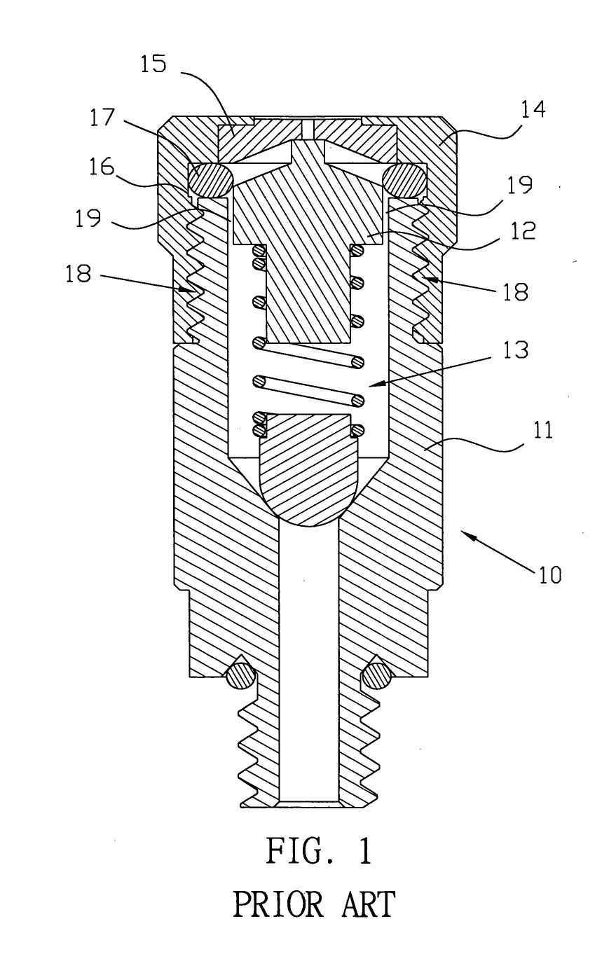

FIG. 2 is an exploded view showing the invention.

FIG. 3 is a schematic illustration showing the assembly of a body and an anti-leakage ring of the invention.

FIG. 4 is a schematic illustration showing the use of the invention.

### DETAILED DESCRIPTION OF THE INVENTION

The present invention will be apparent from the following detailed description, which proceeds with reference to the accompanying drawings, wherein the same references relate to the same elements.

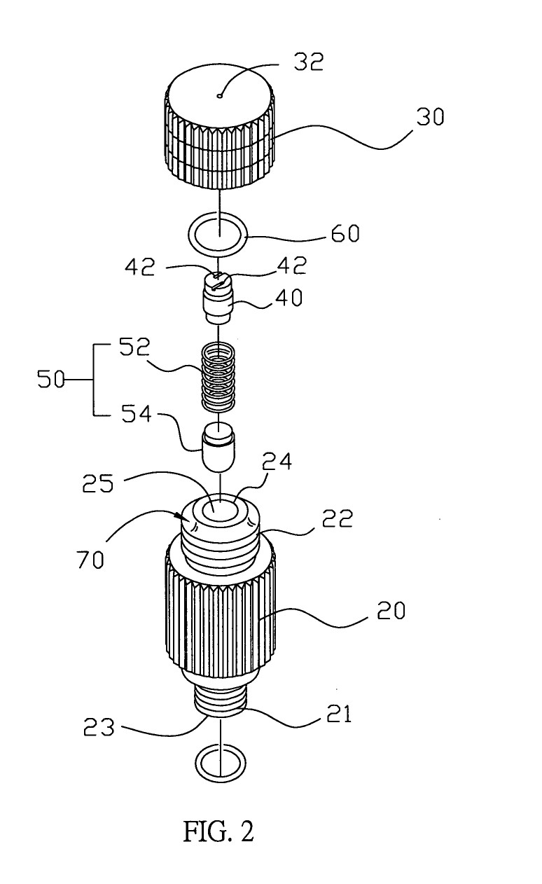

Referring to FIG. 2, an atomizing nozzle includes a body (20), a cover (30), a rotor (40), a leak-stop assembly (50) and an anti-leakage ring (60).

More specifically, one axial end of the body (20) is a first end (21), and the other axial end of the body (20) is a second end (22). An inlet (23) is located at the first end (21), an outlet (24) is located at the second end (22), and a channel (25) connects the inlet (23) to the outlet (24).

The cover (30) has a water jetting hole (32). The cover (30) is disposed on the second end (22) of the body (20) by way of screwing. The anti-leakage ring (60) is disposed between the cover (30) and the body (20).

The rotor (40) is movably accommodated within the channel (25) of the body (20). One end of the rotor (40) has a slot (42). The leak-stop assembly (50) is composed of a spring (52) and a plug (54). The leak-stop assembly (50) is accommodated within the channel (25) and disposed between the rotor (40) and the inlet (23).

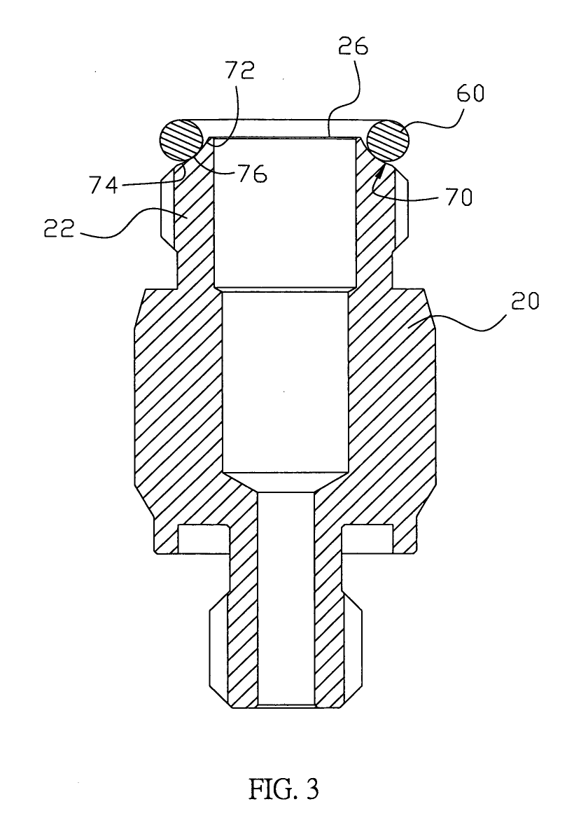

As shown in FIGS. 2 and 3, an annular accommodating groove (70) is formed on the second end (22) of the body (20), and the anti-leakage ring (60) is disposed in the accommodating groove (70).

Referring again to FIG. 3, the accommodating groove (70) has a first edge (72), a second edge (74) and a supporting surface (76) disposed between the first edge (72) and the second edge (74). The first edge (72) is closer to an end surface (26) of the second end (22) of the body (20) than the second edge (74), and the supporting surface (76) is an inclined surface. In detail, the supporting surface (76), the first edge (72) and the second edge (74) constitute an arced, curved surface.

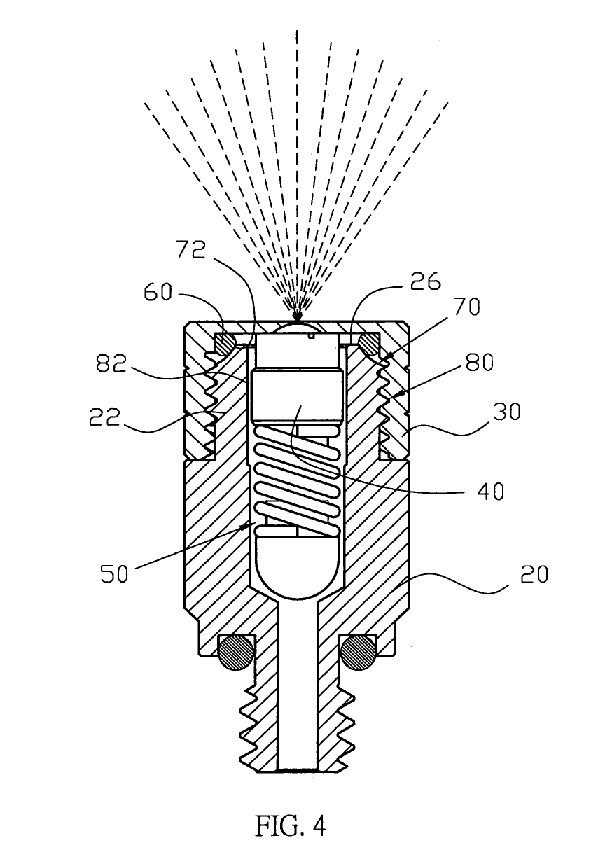

As shown in FIG. 4, after the elements are assembled, the anti-leakage ring (60) is pressed by the cover (30) and corresponds to a screwing position (80) between the cover (30) and the body (20), so that the water or liquid cannot flow reversely or leak to the screwing position (80).

Furthermore, because the accommodating groove (70) has the inclined, arced and curved surface structure, the deformation of the anti-leakage ring (60) is still restricted by the first edge (72) without extending to the end surface (26) of the second end (22) of the body (20). In other words, the anti-leakage ring (60) is free from corresponding to a gap (82) between the body (20) and the rotor (40), so the water or liquid can smoothly flow through the gap (82) and be sprayed out.

When the mist is not to be sprayed, the leak-stop assembly (50) can stop the water, remained in the conduit (not shown) of the spraying system, from entering.

Because the accommodating groove (70) is formed on the second end (22) of the body (20), the accommodating groove (70) can be easily and conveniently machined. In addition, it is understood, from the above-mentioned description, that the invention has the significant anti-leakage function and cannot affect the normal function of the atomizing nozzle.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. An atomizing nozzle with an anti-leakage function, the atomizing nozzle comprising:
a body having one axial end being a first end, and the other axial end being a second end, wherein an inlet is located at the first end, an outlet is located at the second end, and a channel connects the inlet to the outlet;
a cover disposed on the second end of the body;
a rotor movably accommodated within the channel of the body; and
an anti-leakage ring disposed between the body and the cover;
wherein the second end of the body has an annular accommodating groove for supporting the anti-leakage ring.

2. The nozzle according to claim 1, wherein the accommodating groove has a first edge and a second edge, a supporting surface is disposed between the first edge and the second edge, the first edge is closer to an end surface of the second end than the second edge, and the supporting surface is an inclined surface.

3. The nozzle according to claim 1, wherein the supporting surface, the first edge and the second edge are connected together to form an arced, curved surface.

4. The nozzle according to claim 1, further comprising a leak-stop assembly, which is composed of a spring and a plug, disposed in the channel, and disposed between the rotor and the inlet.
